(19) United States
(12) Patent Application Publication
(10) Pub. No.: US 2017/0270893 A1
(43) Pub. Date: Sep. 21, 2017

(54) Method for Divisionally Displaying Screen Pictures of Multiple Web Browser Pages of Handheld Computer on External Monitor

(71) Applicant: Gary Kung, Taipei City (TW)

(72) Inventor: Gary Kung, Taipei City (TW)

(73) Assignee: I/O INTERCONNECT, LTD., Santa Ana, CA (US)

(21) Appl. No.: 15/076,640

(22) Filed: Mar. 21, 2016

(51) Int. Cl. G09G 5/00; G06T 3/40; G06F 3/14

(52) U.S. Cl. CPC G09G 5/006; G06F 3/1454; G06T 3/40; G09G 2370/16

(57) ABSTRACT

The method includes the steps of: a) acquiring a display resolution of an external monitor; b) acquiring screen pictures of web browser pages of a smartphone; c) determining a quantity of screen divisions of the external monitor according to information acquired in step b); d) resizing the screen pictures acquired in step b) to match one of the screen divisions according to the display resolution; e) combining the screen pictures resized in step d) into an integrated screen picture with multiple screen divisions; and f) displaying the integrated screen picture on the external monitor.

### BACKGROUND OF THE INVENTION

1. Technical Field

The invention relates to combination of an external monitor and a handheld computer such as a smartphone or tablet, particularly to displaying screen pictures of multiple web pages of a handheld computer on an external monitor.

2. Related Art

Handheld computers, such as smartphones and tablets, have become essential for most people. Users of handheld computers have the need to connect their handheld computers to an external monitor such as a TV set that provides a much larger display. Because most monitors are oriented horizontally, but a handheld computer can be held upright or horizontally, this can lead to underutilized screen real estate when projecting screen picture of the handheld computer onto the monitor. When the handheld computer is held horizontally a screen picture of a handheld computer can be expanded in proportion to mostly fill the screen area on a monitor, whereas when the handheld computer is held upright, a screen picture of the handheld computer, expanded in proportion, can only fill up to the height of the monitor. Under the latter situation there will be unused blank spaces on either side of the screen picture. This is a poor utilization of displayable area of monitor. Such wasted displayable areas could be effectively utilized. However, there is no solution on the market yet.

### SUMMARY OF THE INVENTION

An object of the invention is to provide a method for divisionally displaying screen pictures of multiple web browser pages of a handheld computer on an external monitor, which can automatically utilize the whole displayable area of the external monitor to display multiple web browser pages of a handheld computer. Thus the displayable area of an external monitor will not be wasted while permitting users to simultaneously view multiple web pages.

To accomplish the above said object, the method for divisionally displaying screen pictures of multiple web browser pages of a handheld computer on an external monitor of the invention includes the steps of:

a) operatably connecting the handheld computer to the external monitor through a controller;

b) acquiring a display resolution of the external monitor;

c) acquiring screen pictures of web browser pages of the handheld computer;

d) determining a quantity of screen divisions of the external monitor according to information acquired in step c);

e) resizing the screen pictures acquired in step c) to match one of the screen divisions according to the display resolution;

f) combining the screen pictures resized in step e) into an integrated screen picture with multiple screen divisions; and

g) displaying the integrated screen picture on the external monitor.

### BRIEF DESCRIPTION OF THE DRAWINGS

FIG. 1 is a schematic view of hardware arrangement of the invention; and

FIG. 2 is a flowchart of the method of the invention.

### DETAILED DESCRIPTION OF THE INVENTION

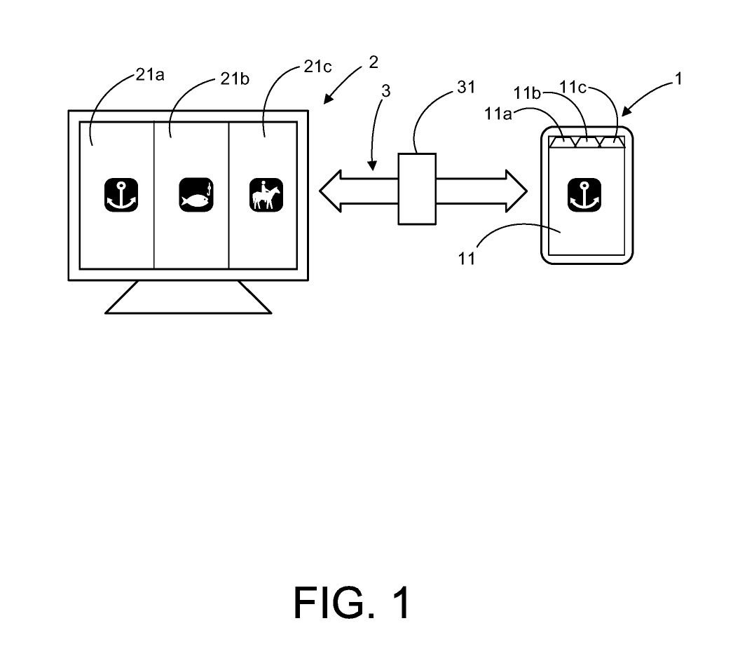

Please refer to FIG. 1. The invention provides a method for divisionally displaying screen pictures of multiple web browser pages of a handheld computer 1 on an external monitor 2. The handheld computer 1 may be a smartphone or tablet computer based upon an Android operating system. The external monitor 2 may be a TV set.

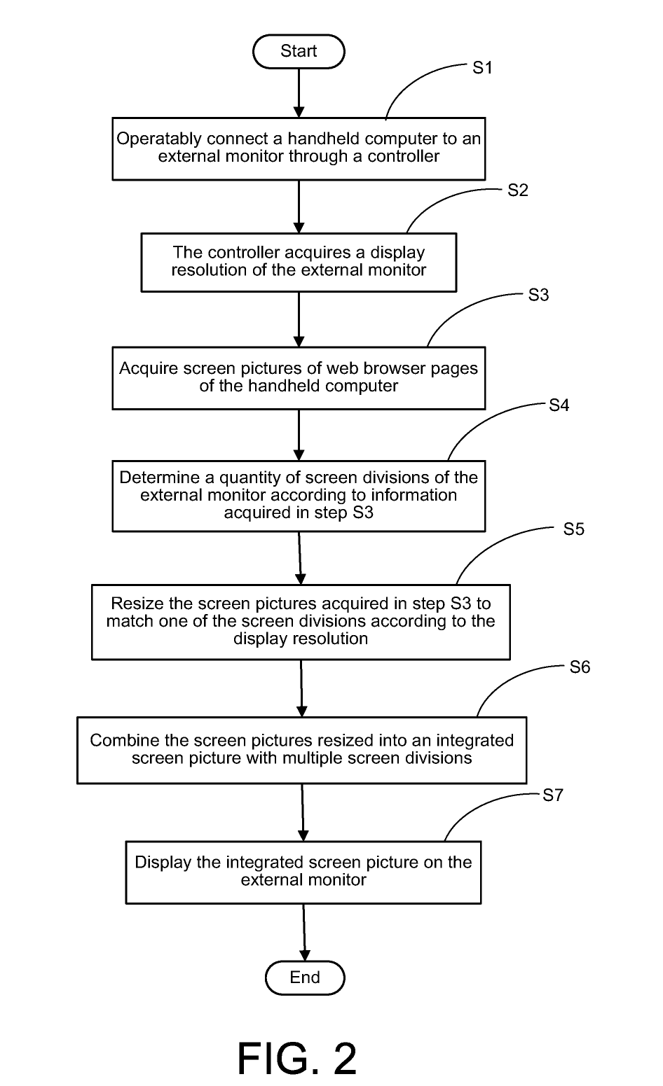

Please refer to FIG. 2, which shows a flowchart of the method of the invention. In step S1, the handheld computer 1 is operatably connected to the external monitor 2. The connection between the handheld computer 1 and the external monitor 2 is a USB (universal serial bus) cable 3 with a controller 31. As a result, a screen picture of the handheld computer 1 can be projected on the external monitor 2. Additionally, both the handheld computer 1 and the controller 31 are separately installed with proprietary software applications. Then a communication channel is created between the handheld computer 1 and the external monitor 2 through the controller 31.

In step S2, the proprietary software application in the controller 31 acquires a display resolution of the external monitor 2.

In step S3, the software application in the handheld computer 1 acquires screen pictures 11 of web browser pages of the handheld computer 1. For example, as shown in FIG. 1, when a user opens three web browser pages, three screen pictures of these three web pages will be separately acquired. On the handheld computer 1, only one web browser page 11 will be displayed. However, each of all web browser pages 11 will be shown with a tab 11a, 11b, 11c. All screen pictures of these web browser pages are stored to multiple Virtual Displays of Android. It is noted that the original Android operating system provides only one Virtual Display, the software application of the invention creates multiple Virtual Displays for storing multiple web browser pages.

In step S4, according to the information acquired in step S3, the software application in the controller 31 determines a quantity of screen divisions 21a, 21b, 21c of the external monitor 2. Of course, the quantity of screen divisions 21a, 21b, 21c is the same as that of the web browser pages 11 acquired in step S3.

In step S5, the software application in the controller 31 resizes the screen pictures acquired in step S3 to match one of the screen divisions 21a, 21b, 21c. Because the controller 31 has acquired a display resolution of the external monitor 2 in step S2, the controller 31 is able to resize the screen pictures 11 of the web browser pages to match one of the screen divisions 21a, 21b, 21c of the external monitor 2.

In step S6, the software application in the controller 31 combines the screen pictures resized in step S5 into an integrated screen picture with multiple screen divisions. Because the screen pictures have been resized in step S5, they can be combined to fit the external monitor 2 exactly.

Finally, in step S7, the controller 31 sends the integrated screen picture to the external monitor 2 to display it on the external monitor 2 as shown in FIG. 1.

In sum, by the method of the invention, all of the web browser pages of a handheld computer 1 can be simultaneously displayed on an external monitor 2. This is very helpful for those users who connect their handheld computers to an external monitor.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for divisionally displaying screen pictures of multiple web browser pages of a handheld computer on an external monitor, comprising:
a) operatably connecting the handheld computer to the external monitor through a controller;
b) acquiring a display resolution of the external monitor;
c) acquiring screen pictures of web browser pages of the handheld computer;
d) determining a quantity of screen divisions of the external monitor according to information acquired in step c);
e) resizing the screen pictures acquired in step c) to match one of the screen divisions according to the display resolution in step b);
f) combining the screen pictures resized in step e) into an integrated screen picture with multiple screen divisions; and
g) displaying the integrated screen picture on the external monitor.

2. The method of claim 1, wherein the handheld computer is a smartphone or tablet computer.

3. The method of claim 1, wherein the external monitor is a TV set.
